(19) United States
(12) Patent Application Publication
(10) Pub. No.: US 2008/0085688 A1
(43) Pub. Date: Apr. 10, 2008

(54) METHOD AND SYSTEM FOR DATA RETRIEVAL USING PUSH TO TALK

(75) Inventor: ANTHONY V. SKUJINS, TEMPE, AZ (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/539,431

(22) Filed: Oct. 6, 2006

(51) Int. Cl. H04B 1/18

(52) U.S. Cl. 455/187.1

(57) ABSTRACT

A method (50) and system (10) of retrieving data using a push-to-talk connection includes the wireless communication unit (12), a user interface (14) allowing a user to selectively choose at least one link (16) from the user interface, and a processor (18) coupled to the user interface. The processor can be programmed to transmit the at least one link or a representation of the at least one link to a server (22) using the push-to-talk connection and receive data associated with the at least one link using the push-to-talk connection. The system can enable the user to selectively create (51) the at least one link to a website for subsequent retrieval of data from the website. The processor can be store (52) the at least one link at the wireless communication unit and upload the at least one link to the server having access to a website.

### FIELD

The invention relates generally to data retrieval, and more particularly to a method and system of data retrieval using a push-to-talk (PTT) connection.

### BACKGROUND

Instant access to information without having to go through redundant menus or layers of searches is not readily available using current wireless technologies. Access to information many users ultimately want to obtain typically involves traversing a number of menus and a significant amount of overhead causing users to spend large amounts of time. This disclosure presents a method of instant data retrieval based upon the existing PTT technology.

One known system as described in U.S. Patent Publication No. 20050215236 A1 does providing information for mobile users, but based upon delivering of archived personal content of mobile users and/or material selected on the basis of archived personal content. This patent publication discusses archived data to a mobile device based upon data requests but fails to use or contemplate PTT connections.

### SUMMARY

Embodiments in accordance with the present invention can provide a method and system for retrieving data using a push-to-talk connection. Embodiments herein can involve user-defined set-up of information links as desired by the user.

In a first embodiment of the present invention, a method of retrieving data using a push-to-talk connection can include the steps of user selectively accessing at least one link from a wireless communication unit, transmitting the at least one link or a representation of the at least one link to a server using the push-to-talk connection, and receiving data associated with the at least one link using the push-to-talk connection. The push-to-talk connection can be a push-to-talk over cellular (PoC) connection and can be performed over an iDEN network, a UTMS network, a CDMA network, a WiMax network, or a GSM network for example. The method can further include the step of user selectively creating the at least one link to a website for retrieval of data from the website. The method can enable a user to selectively create the at least one link using a computer having a web browser and interface or link to the internet or using a mobile web browser or a JAVA or BREW software application on the wireless communication unit. The method can further include storing the at least one link at a wireless communication unit and uploading the at least one link to the server having access to a website.

In a second embodiment of the present invention, a system of retrieving data using a push-to-talk connection can include a wireless communication unit, a user interface on the wireless communication unit allow a user to selectively choose at least one link from the user interface, and a processor coupled to the user interface. The processor can be programmed to transmit the at least one link or a representation of the at least one link to a server using the push-to-talk connection and receive data associated with the at least one link using the push-to-talk connection. The system can enable the user to selectively create the at least one link to a website for subsequent retrieval of data from the website and more specifically can enable the user to selectively create the at least one link using a computer having a web browser and interface or link to the internet or using a mobile web browser on the wireless communication unit. The processor can be further programmed to store the at least one link at a wireless communication unit and upload the at least one link to the server having access to a website. As noted above, the push-to-talk connection can be a push-to-connect over cellular connection. The push-to-talk connection can also be performed over an iDEN network, a UTMS network, a CDMA network, a WiMax network or a GSM network for example.

In a third embodiment of the present invention, a wireless communication unit capable of retrieving data using a push-to-talk connection can include a transceiver; a user interface on the wireless communication unit allowing a user to selectively choose at least one link from the user interface, and a processor coupled to the user interface and transceiver. The processor can be programmed to transmit the at least one link or a representation of the at least one link to a server using the push-to-talk connection and receive data associated with the at least one link using the push-to-talk connection. The wireless communication unit can enables the user to selectively create the at least one link to a website for subsequent retrieval of data from the website and more specifically enables the user to selectively create the at least one link using a computer having a web browser and interface or link to the internet or using a mobile web browser on the wireless communication unit. The processor can be programmed to store the at least one link at a wireless communication unit using a mobile web browser or a JAVA or BREW software application on the wireless communication unit. The processor can further be programmed to upload the at least one link to the server having access to a website. As noted above, the push-to-talk connection can be a push-to-connection performed over an iDEN network, a UTMS network, a CDMA network, a WiMax network or a GSM network for example.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a block diagram of a system of retrieving data using a push-to-talk connection in accordance with an embodiment of the present invention.

FIG. 2 is a flow chart illustrating a method of retrieving data using a push-to-talk connection in accordance with an embodiment of the present invention.

FIG. 3 is a block diagram of another wireless device and system of retrieving data using a push-to-talk connection in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in personal digital assistants, cellular phones, laptop computers, desktop computers, and the like. Generally speaking, pursuant to these various embodiments, a method or system herein can provide instant access to data through Push-To-Talk (PTT) capabilities using a set of predefined links which can be user created and/or user selectable. Data, in this regard, can include information which is highly desirable, important or required for a given task or job. Examples of such data can include, sports scores, stock quotes, futures pricing, currency exchange rates, weather conditions, corporate schedules, internal building temperatures, and security status to just name a few.

Current methods of information retrieval on cellular phones are limited through specific web sites requiring a Wireless Application Protocol (WAP) or other form of internet browser. The web site itself can contain several layers of interfaces which require navigation for retrieval of specific data. For example, a subscribed user (subscriber) that desires a particular set of NFL Sunday scores for the NFC West using existing technology would initially choose a web site which lists a menu of links for news, sports, finance and weather. From these links, the subscriber chooses the sports link with a new submenu listing links for Football, Basketball, Hockey, Baseball, etc. Choosing the Football link, resulting in another new submenu listing College, NFL, Arena Football League, and High School. The subscriber would again choose the NFL submenu resulting in links for scores, news, standings, and tickets. Finally, the subscriber can choose the desired scores link providing a listing of current NFL scores. Note the subscriber usually is provided with all NFL scores for the current week without regards to a specific region, such as the NFC West. In the example above, the subscriber had to navigate from a main menu, to four submenus representing five layers of links to retrieve a final listing of desired scores. If additional data is desired, the subscriber is again required to spend time navigating through layers of menus to retrieve the new data. Additional time is spent if the subscriber accidentally presses a wrong key causing a switch from the cellular phone's browser menu to the idle menu.

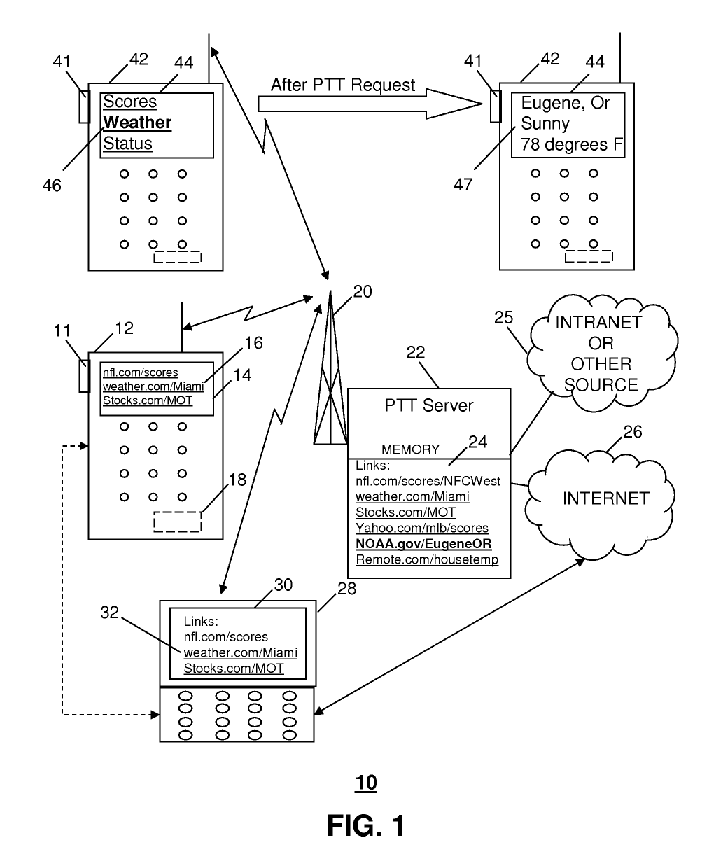

In contrast, in accordance with the embodiments of the present invention and as illustrated in the system 10 of FIG. 1, a subscriber can store predetermined links that provide direct access to the desired information without the need to traverse numerous menus. Storage of such links 16 can be done at a subscriber wireless device 12 or at a server 22 within a memory 24 at the server 22. The links can then be used to retrieve data from the Internet 26, or other sources 25 such as an Intranet network. Furthermore, access to such information can be achieved using PTT technology. Currently, PTT is found in several cellular technologies such as iDEN and CDMA. PTT provides the means of a quick audio communications connection between subscribers based on prioritized networked traffic channels, but currently does not provide quick access to predefined links as might be stored by a user. Thus, the PTT technology can be used to provide a prioritized channel as usual, but with the exception that preferred data can be exchanged instead of audio. While audio is shared between subscribers during a typically PTT communications connection, embodiments herein can enable the sharing of data between a cellular phone or other wireless device and a data server.

Again referring to FIG. 1, the system 10 of retrieving data using a push-to-talk connection can include the wireless communication unit 12, a user interface 14 on the wireless communication unit allowing a user to selectively choose at least one link 16 from the user interface 14, and a processor 18 coupled to the user interface. The processor 18 can be programmed to transmit the at least one link 16 or a representation of the at least one link to a server 22 using the push-to-talk connection and receive data associated with the at least one link using the push-to-talk connection. The system 10 can enable the user to selectively create the at least one link to a website for subsequent retrieval of data from the website and more specifically can enable the user to selectively create the at least one link using a computer 28 having a web browser and interface 30 or link to the internet 26 (or other source 25) or using a mobile web browser on the wireless communication unit 12. The processor 18 can be further programmed to store the at least one link 16 at the wireless communication unit 12 and upload the at least one link to the server 22 via wireless infrastructure equipment 20 (and 22) having access to a website. As noted above, the push-to-talk connection can be a push-to-connect over cellular connection or any other PTT connection which can be performed over an iDEN network, a UTMS network, a CDMA network, a WiMax network or a GSM network for example.

As noted above, links can be pre-defined data links providing access to information such as scores, stock quotes, weather, and can include other custom titles as determined by the subscriber. Link definitions can be specific access points to web server addresses, remote data servers or specific IP addresses. These links can be created through a web interface on a person computer such as computer 28 or through a Java or BREW software application on a cellular phone or other wireless client device (12). The link definitions can be uploaded to the server 22 and stored for retrieval via PTT requests sent from the cellular phone or wireless client while the actual links are stored on the cellular phone. Alternatively, the actual links can be stored at the server 22 while only a representation of the links are stored at the cellular phone or wireless client.

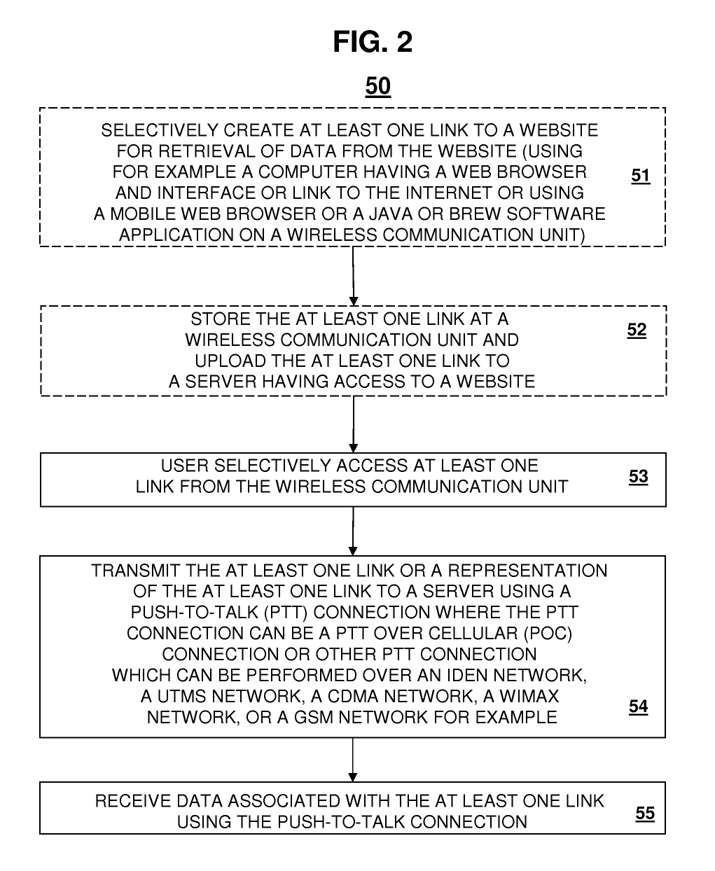

Referring to FIG. 2, a flow chart illustrating a method 50 of retrieving data using a push-to-talk connection can include the step 53 of user selectively accessing at least one link from a wireless communication unit, transmitting the at least one link or a representation of the at least one link at step 54 to a server using the push-to-talk connection, and receiving data associated with the at least one link using the push-to-talk connection at step 54. The push-to-talk connection can be a push-to-talk over cellular (PoC) connection and can be performed over an iDEN network, a UTMS network, a CDMA network, a WiMax network, or a GSM network for example. The method 50 can further optionally include the step 51 of user selectively creating the at least one link to a website for retrieval of data from the website. The method can enable a user to selectively create the at least one link using a computer having a web browser and interface or link to the internet or using a mobile web browser or a JAVA or BREW software application on the wireless communication unit. The method 50 can further optionally include storing the at least one link at a wireless communication unit and uploading the at least one link to the server having access to a website at step 52.

In the specific example of a cellular phone subscriber using a cellular phone to access such links, a subscriber can access data using the predefined links via the cellular phone's idle menu where a link can be selected through a submenu. Pressing a PTT button 11 as shown in FIG. 1 can set up a prioritized networked traffic channel from the cellular phone 12 to a server (22) where the data link type request is sent. The server retrieves the link definition based on the sent data link and replies to the cellular phone through the prioritized networked traffic channel with the requested data. The data is then instantly displayed to the subscriber on the cellular phone's display. This method therefore provides instant or virtual instant access of data through PTT connections using a two level menu with only a single button selection. The data can remain on the display until the user either chooses a new PTT link or ends the session returning to the cellular phone's idle screen.

For example, Joe, a subscriber using wireless device or cellular phone 42 as shown in FIG. 1, can define three links and designates them as Scores, Weather and Status. Through a Java program on his user interface or display 44 on his cellular phone, Joe defined scores as daily MLB baseball scores from a popular sports portal, weather as the local daily forecast for Eugene, Oreg. from a government portal, and status as current temperature in his house from his home based web server. During his commute to work, Joe decides to check the current weather. From Joe's cellular phone idle menu, he picks the PTT links submenu and highlights the weather link 46. Pressing the PTT button 41 on the side of the cellular phone 42, the weather data 47 appears on the user interface or display 44 after several seconds.

Embodiments herein alleviate the difficulties and reduce the amount of time required to access pertinent information. Since most information on a cellular phone is acquired through included browsers, subscribers become frustrated in the amount of time required and levels of necessary menus. PTT resolves this problem by creating a new easy method of data retrieval. These techniques can be applied to cellular phones and other devices which incorporate Push-To-Talk (PTT) technology. Although Motorola's iDEN technology is currently known for PTT, other cellular technologies are starting to apply PTT techniques including CDMA, GSM and UTMS.

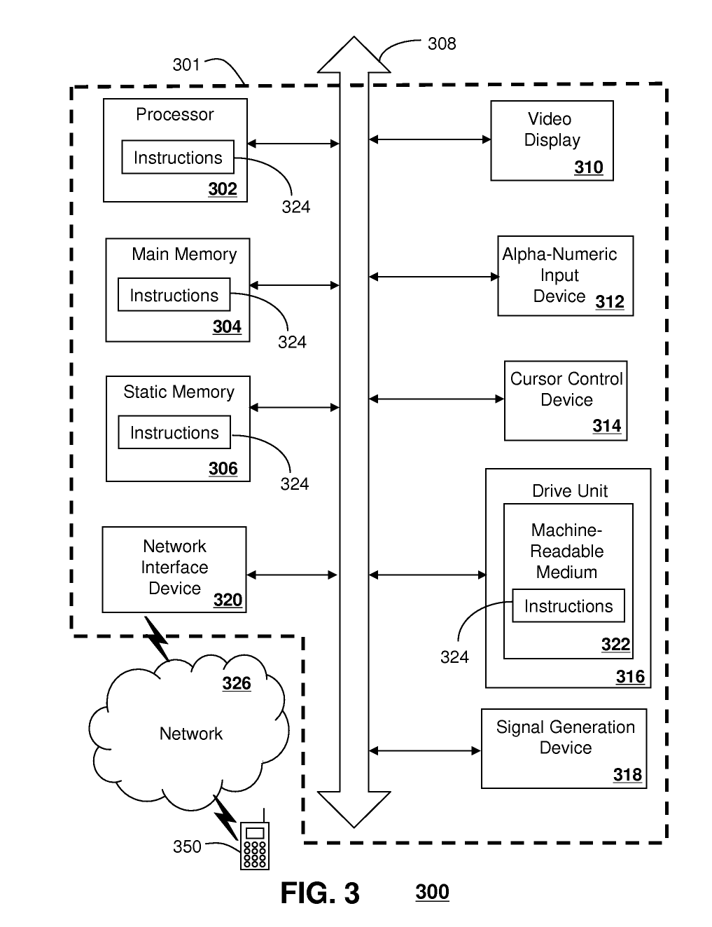

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 301 and a sending device 350 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 can include a controller or processor 302 (e.g., a central processing unit (CPU), a graphics processing unit (GPU, or both), a main memory 304 and a static memory 306, which communicate with each other via a bus 308. The computer system 300 may further include a presentation device such as a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control that can also serve as a presentation device) and a network interface device 320. Of course, in the embodiments disclosed, many of these items are optional.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of retrieving data using a push-to-talk connection, comprising the steps of:
user selectively accessing at least one link from a wireless communication unit;
transmitting the at least one link or a representation of the at least one link to a server using the push-to-talk connection; and
receiving data associated with the at least one link using the push-to-talk connection.

2. The method of claim 1, wherein the method further comprises the step of user selectively creating the at least one link to a website for retrieval of data from the website.

3. The method of claim 2, wherein the method enables a user to selectively create the at least one link using a computer having a web browser and interface or link to the internet or using a mobile web browser or a JAVA or BREW software application on the wireless communication unit.

4. The method of claim 1, wherein the method further comprises the step of storing the at least one link at a wireless communication unit.

5. The method of claim 1, wherein the method further comprises the step of uploading the at least one link to the server having access to a website.

6. The method of claim 1, wherein the push-to-talk connection is a push-to-talk over cellular (PoC) connection.

7. The method of claim 1, wherein the push-to-talk connection is performed over an iDEN network, a UTMS network, a CDMA network, a WiMax network, or a GSM network.

8. A system of retrieving data using a push-to-talk connection, comprising:
a wireless communication unit;
a user interface on the wireless communication unit allow a user to selectively choose at least one link from the user interface; and
a processor coupled to the user interface, wherein the processor is programmed to:
transmit the at least one link or a representation of the at least one link to a server using the push-to-talk connection; and
receive data associated with the at least one link using the push-to-talk connection.

9. The system of claim 8, wherein the system enables the user to selectively create the at least one link to a website for subsequent retrieval of data from the website.

10. The system of claim 9, wherein the system enables the user to selectively create the at least one link using a computer having a web browser and interface or link to the internet or using a mobile web browser on the wireless communication unit.

11. The system of claim 8, wherein the processor is further programmed to store the at least one link at a wireless communication unit.

12. The system of claim 8, wherein the processor is further programmed to upload the at least one link to the server having access to a website.

13. The system of claim 8, wherein the push-to-talk connection is a push-to-connect over cellular connection.

14. The system of claim 8, wherein the push-to-talk connection is performed over an iDEN network, a UTMS network, a CDMA network, a WiMax network or a GSM network.

15. A wireless communication unit capable of retrieving data using a push-to-talk connection, comprising:
a transceiver;
a user interface on the wireless communication unit allowing a user to selectively choose at least one link from the user interface; and
a processor coupled to the user interface and transceiver, wherein the processor is programmed to:
transmit the at least one link or a representation of the at least one link to a server using the push-to-talk connection; and
receive data associated with the at least one link using the push-to-talk connection.

16. The wireless communication unit of claim 15, wherein the wireless communication unit enables the user to selectively create the at least one link to a website for subsequent retrieval of data from the website.

17. The wireless communication unit of claim 16, wherein the wireless communication unit enables the user to selectively create the at least one link using a computer having a web browser and interface or link to the internet or using a mobile web browser on the wireless communication unit.

18. The wireless communication unit of claim 15, wherein the processor is further programmed to store the at least one link at a wireless communication unit using a mobile web browser or a JAVA or BREW software application on the wireless communication unit.

19. The wireless communication unit of claim 15, wherein the processor is further programmed to upload the at least one link to the server having access to a website.

20. The wireless communication unit of claim 15, wherein the push-to-talk connection is a push-to-connection is performed over an iDEN network, a UTMS network, a CDMA network, a WiMax network or a GSM network.
